(19) United States
(12) Patent Application Publication
(10) Pub. No.: US 2012/0314293 A1
(43) Pub. Date: Dec. 13, 2012

(54) Article with 3D Lively Figure

(76) Inventor: Chien-Fu Chang, Luzhu Township (TW)

(21) Appl. No.: 13/157,388

(22) Filed: Jun. 10, 2011

(51) Int. Cl. G02B 27/22; G02B 1/10

(52) U.S. Cl. 359/580; 359/577

(57) ABSTRACT

An article includes a light-transmittable substrate having opposite first and second surfaces spaced in a height direction. A first pattern is provided on the first surface of the light-transmittable substrate. A plurality of spaced first lines is provided on a face of the first pattern. A second pattern is provided on the second surface of the light-transmittable substrate. A plurality of spaced second lines is provided on a face of the second pattern. The first lines intersect the second lines when viewed from the face of the first pattern, forming a Moire pattern and creating Moire effect. Light beams passing through the light-transmittable substrate via the first pattern or the second pattern according to a viewing angle of a viewer are refracted to represent a 3D lively figure.

### BACKGROUND OF THE INVENTION

The present invention relates to an article with a 3D animated figure and, more particularly, to an article representing a 3D (three dimensional) lively figure with a three dimensional effect by forming a Moire pattern.

Lenticular effects include 3D, flip, animation, morph, and zoom. FIG. 1 shows a method for making an image with a lenticular effect, such as flip. Firstly, each of images A and B (such as computer graphic files) is divided into a plurality of stripe images. The stripe images of images A and B are overlapped to form an interlaced image. The interlaced image is printed out on a sheet of paper and then laminated on a lenticular lens sheet. In another approach, the interlaced image is directly printed out on a rear side of the lenticular lens sheet. A viewer can see images A and B from different angles. However, the visibility can not be increased by a reflective film such that the images can not be clearly seen except particular figures. Currently available 3D picture stickers, 3D landscape paintings or 3D decorative paintings require multi-layer slitting printing as well as internal reflection by a reflective layer of a prism to obtain a picture with a mirage effect. However, the procedures and the manufacturing costs are increased.

Currently, Moire effect is only used in plane printing or in simulating effects on a computer screen or in water wave processing of a textile, failing to provide a three dimensional lively effect.

### BRIEF SUMMARY OF THE INVENTION

An objective of the present invention is to provide an article representing an aesthetic, lively 3D figure, providing a unique product with increased product value to increase competitiveness.

An article according to the present invention includes a light-transmittable substrate having opposite first and second surfaces spaced in a height direction. A first pattern is provided on the first surface of the light-transmittable substrate. A plurality of spaced first lines is provided on a face of the first pattern. A second pattern is provided on the second surface of the light-transmittable substrate. A plurality of spaced second lines is provided on a face of the second pattern. The first lines intersect the second lines when viewed from the face of the first pattern, forming a Moire pattern and creating Moire effect. Light beams passing through the light-transmittable substrate via the first pattern or the second pattern according to a viewing angle of a viewer are refracted to represent a 3D lively figure.

In an example, each of the first and second lines has a color. The second pattern includes a light-intransmittable base color.

In another example, the first pattern or the second pattern includes a light-transmittable protective layer.

In an example, the first pattern is a first light-transmittable sheet having an inner face and an outer face. The inner face of the first light-transmittable sheet is bonded to the first surface of the light-transmittable substrate. The outer face of the first light-transmittable sheet forms the face on which the first lines are located. The second pattern is a second light-transmittable sheet having an inner face and an outer face. The inner face of the second light-transmittable sheet is bonded to the second surface of the light-transmittable substrate. The inner face of the second light-transmittable sheet forms the face on which the second lines are located.

In an example, each first line of the first pattern is light-transmittable and has a width larger than 0.1 mm in a width direction perpendicular to the height direction. Each first line of the first pattern is spaced from the face of the first pattern by a spacing in the height direction. The spacing is in a range between 0.1 mm and 5 mm and most preferably larger than 0.3 mm. The light beams passing through the light-transmittable substrate via the first pattern according to the viewing angle of the viewer are refracted to represent the 3D lively figure.

In an example, each first line of the first pattern is located between the face of the first pattern and the second surface of the light-transmittable substrate in the height direction.

In another example, the face of the first pattern is located between the first lines of the first pattern and the second surface of the light-transmittable substrate in the height direction.

The present invention will become clearer in light of the following detailed description of illustrative embodiments of this invention described in connection with the drawings.

### DESCRIPTION OF THE DRAWINGS

FIG. 1 shows a conventional method for making a 3D picture by using flip.

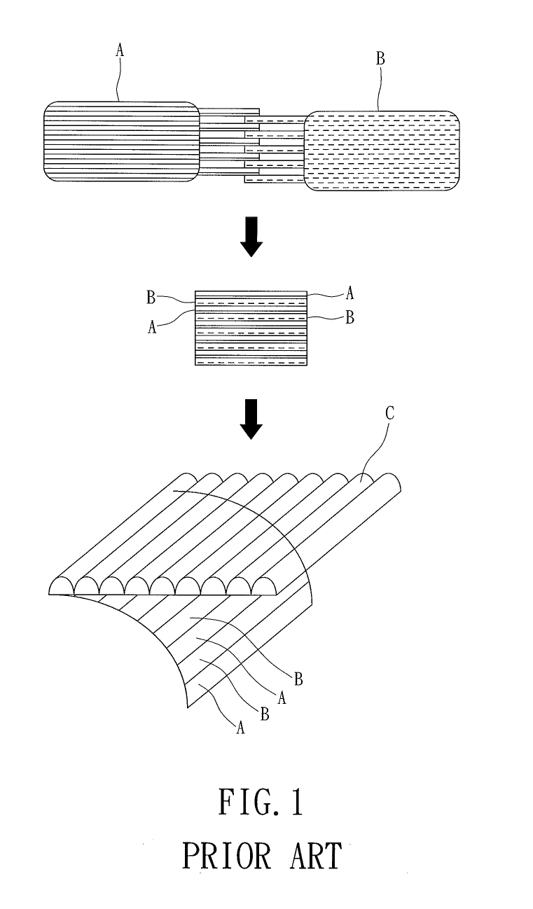

FIG. 2 shows an article with a 3D lively figure of a first embodiment according to the present invention.

FIG. 3 shows a perspective view of the article of FIG. 2, illustrating a 3D lively figure represented by the article.

FIG. 4 shows a perspective view of a modified example of the article of FIG. 2, with the article including a protective layer.

FIG. 5 shows an enlarged, side view of an article with a 3D lively figure of a second embodiment according to the present invention.

FIG. 6 shows an enlarged, side view of a modified example of the article of FIG. 5.

FIG. 7 shows a perspective view of an article with a 3D lively figure of a third embodiment according to the present invention.

FIG. 8 shows an exploded, perspective view of the article of FIG. 7.

FIG. 9 shows a perspective view of the article of FIG. 7, illustrating a 3D lively figure represented by the article.

FIG. 10 shows an enlarged, side view of an article with a 3D lively figure of a fourth embodiment according to the present invention.

FIG. 11 shows an enlarged, side view of a modified example of the article of FIG. 10.

### DETAILED DESCRIPTION OF THE INVENTION

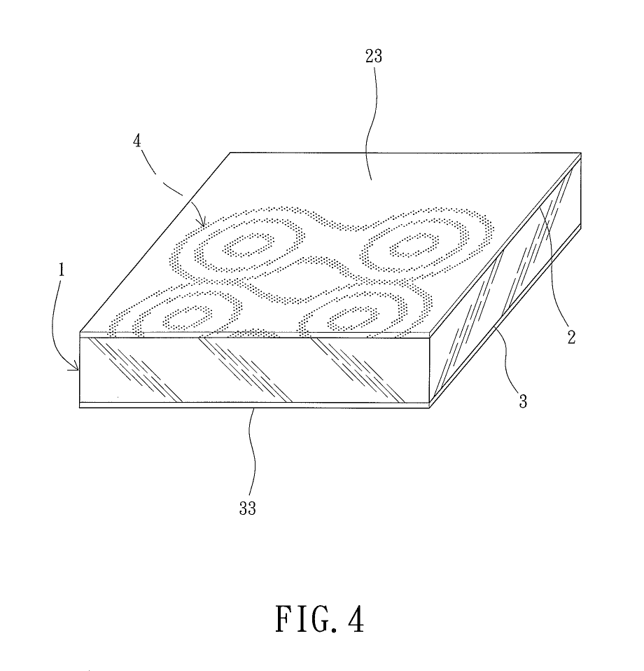

An article with a 3D lively figure according to the present invention can be used as an architectural material, advertising article, container, or decoration. The article utilizes Moire effect to design geometric figures so as to provide first and second patterns 2 and 3 on two surfaces of a light-transmittable substrate 1, creating a 3D lively FIG. 4 with a three dimensional effect.

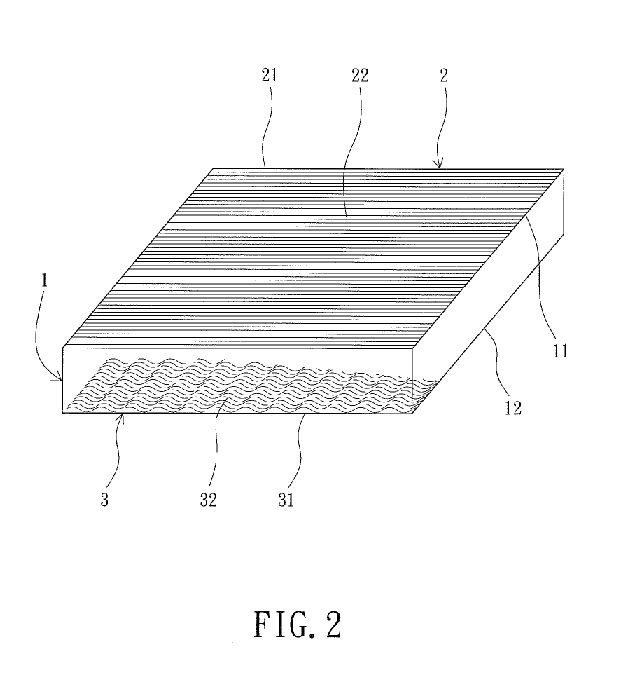

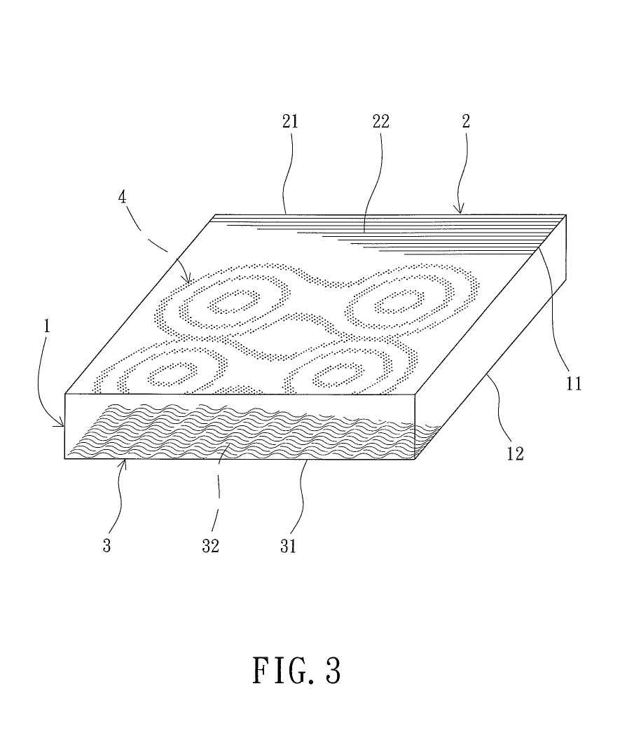

FIGS. 2 and 3 show a first embodiment of the article. Specifically, the article includes a light-transmittable substrate 1 made of transparent or translucent material. The light-transmittable substrate 1 includes opposite first and second surfaces 11 and 12 spaced in a height direction. A first pattern 2 is provided on the first surface 11 of the light-transmittable substrate 1 by such as printing. The first pattern 2 has a face 21 that forms the first surface 11 of the light-transmittable substrate 1 in this embodiment. A plurality of spaced first lines 22 is provided on the face 21 of the first pattern 2 (the first surface 11 of the light-transmittable substrate 1 in this embodiment). Each first line 22 can be a light-transmittable or light-intransmittable color line. Furthermore, a second pattern 3 is provided on the second surface 12 of the light-transmittable substrate 1. The second pattern 3 has a face 31 that forms the second surface 12 of the light-transmittable substrate 1 in this embodiment. A plurality of spaced second lines 32 is provided on the face 31 of the second pattern 3 (the second surface 12 of the light-transmittable substrate 1 in this embodiment). Each second line 32 has a color. The second pattern 2 includes a light-intransmittable base color in the remaining area free of the second lines 32. The first lines 32 intersect the second lines 22 when viewed from the face 21 of the first pattern 2. As an example, each first line 22 intersects some or all of the second lines 32, and each second line 32 intersects some or all of the first lines 22. However, other arrangements of intersection are allowed. In a modified example shown in FIG. 4, a light-transmittable protective layer 23 is bonded to the first pattern 2, and a light-transmittable protective layer 33 is bonded to the second pattern 3, avoiding the first and second lines 22 and 32 from being damaged or scratched.

After manufacture, the first lines 22 of the first pattern 2 intersect the second lines 32 of the second pattern 3 to form a Moire pattern and to create Moire effect. The first and second lines 22 and 32 can be different in shape, spacing, width, inclination, and curvature. Light beams passing through the light-transmittable substrate 1 via the first pattern 2 or the second pattern 3 according to a viewing angle of a viewer are refracted to represent a 3D lively FIG. 4 with a three dimensional effect.

The light-transmittable substrate 1 can be made of various materials with differing hardnesses, such as glass, liuli, acrylic, polyethylene terephthalate (PET), and resins. The first and second surfaces 11 and 12 can be plane, arcuate, or curved. The first and second patterns can be designed according to the required 3D lively FIG. 4.

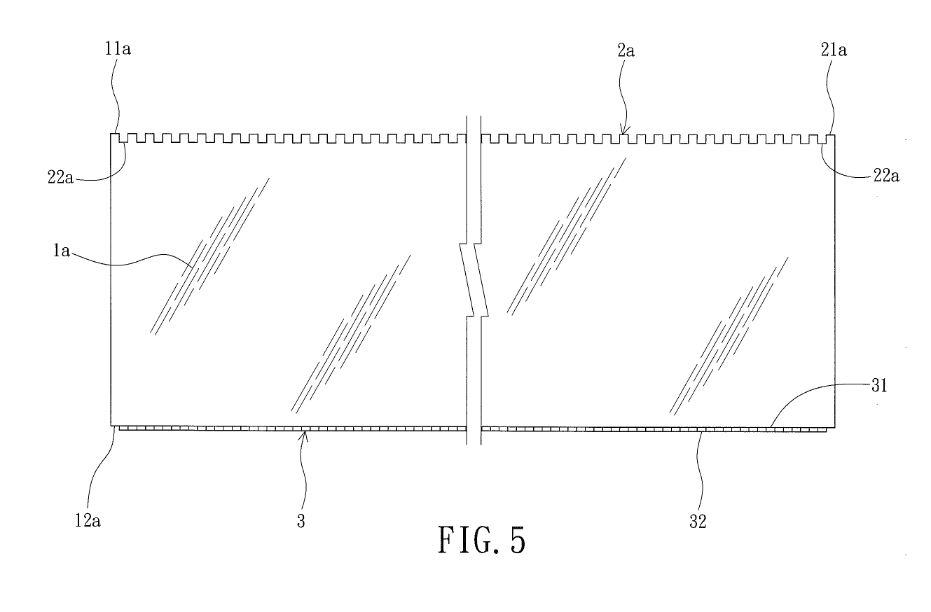

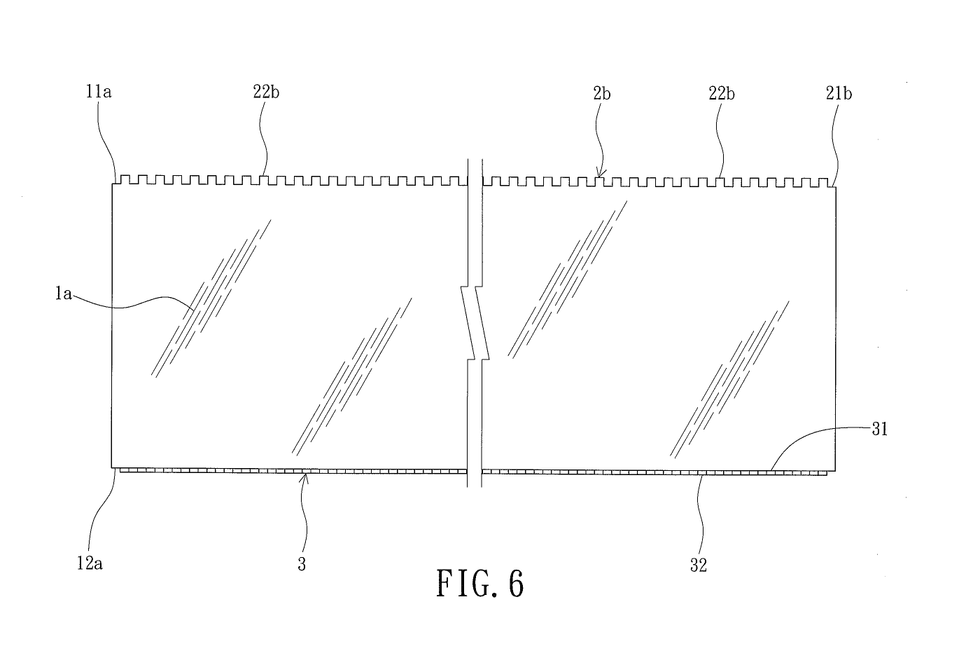

FIG. 5 shows a second embodiment of the article. The first pattern 2a is provided on the first surface 11a of the light-transmittable substrate 1a, and the face 21a of the first pattern 2a forms the first surface 11a. The first lines 22a are formed by molding, extrusion, or cutting. Each first line 22a is light-transmittable and has a width larger than 0.1 mm in a width direction perpendicular to the height direction. Each first line 22a is spaced from the face 21a of the first pattern 2a by a spacing in the height direction. The spacing is in a range between 0.1 mm and 5 mm and most preferably larger than 0.3 mm. The light beams passing through the light-transmittable substrate via the first pattern 2a according to the viewing angle of the viewer are refracted to represent the 3D lively FIG. 4 with a three dimensional effect. In the embodiment shown in FIG. 5, each first line 22a of the first pattern 2a is located between the face 21a of the first pattern 2a and the second surface 12a of the light-transmittable substrate 1a in the height direction. In a modified example shown in FIG. 6, the face 21b of the first pattern 2b is located between the first lines 22b of the first pattern 2b and the second surface 12a of the light-transmittable substrate la in the height direction.

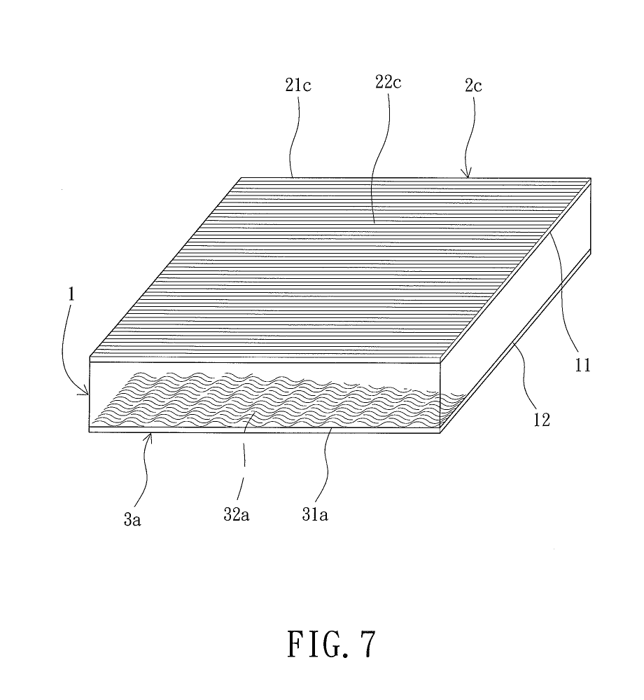

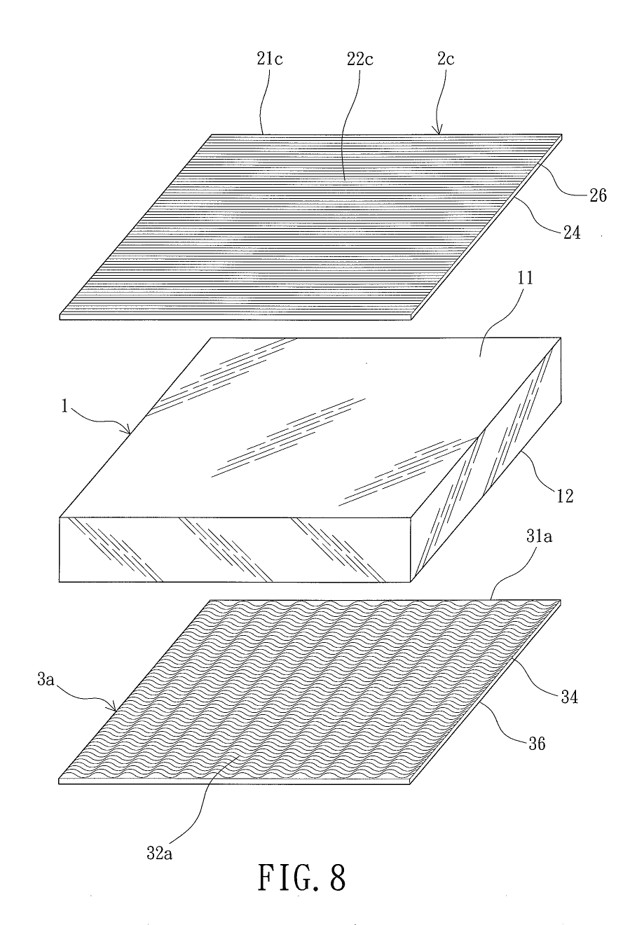

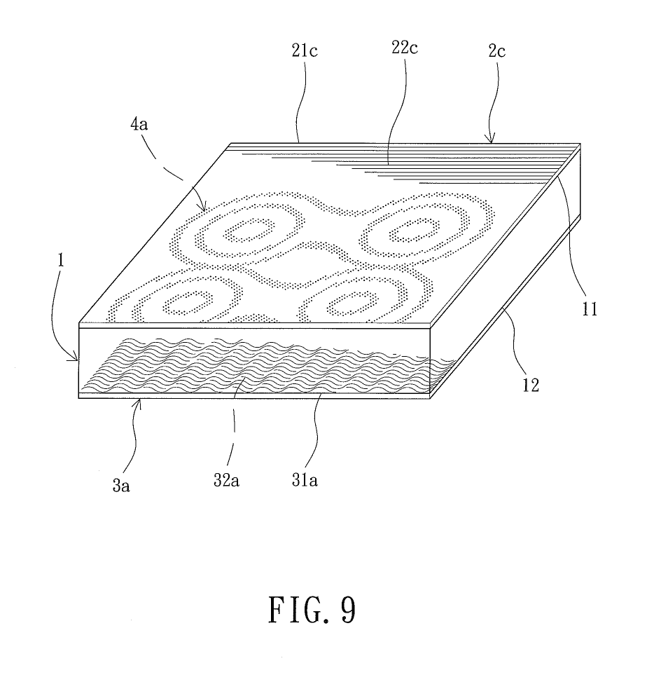

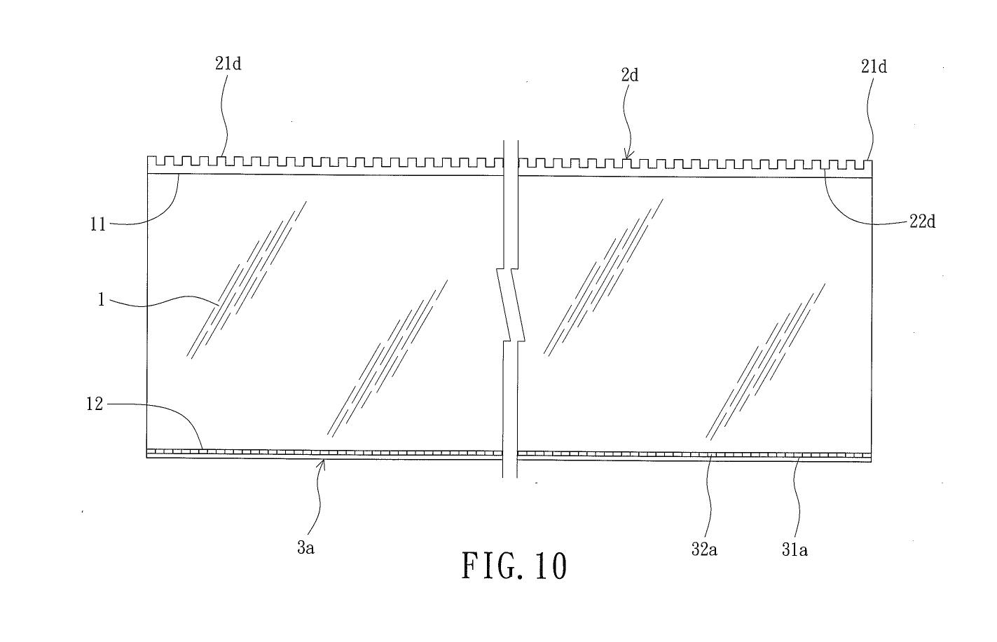

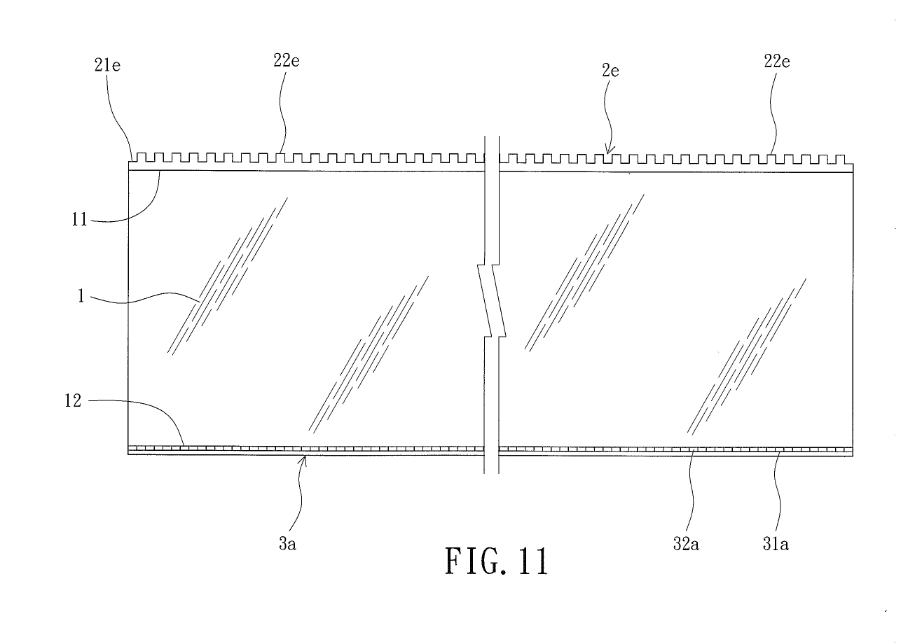

FIGS. 7-9 show a third embodiment of the article. Specifically, the first pattern 2c is a light-transmittable sheet having an inner face 24 and an outer face 26. The inner face 24 of the light-transmittable sheet is bonded to the first surface 11 of the light-transmittable substrate 1. The outer face 26 of the light-transmittable sheet forms the face 21c on which the first lines 22c are located. The first lines 22c are colorless or color lines. Furthermore, the first lines 22c are light-transmittable. The second pattern 3a is a rubber sheet or a light-transmittable sheet having an inner face 34 and an outer face 36. The inner face 34 of the light-transmittable sheet is bonded to the second surface 12 of the light-transmittable substrate 1. The inner face 34 of the light-transmittable sheet forms the face 31a on which the second lines 32a are located. The second liens 32a are color lines. In an example shown in FIG. 10, each first line 22d of the first pattern 2d is located between the face 21d of the first pattern 2d and the second surface 12 of the light-transmittable substrate 1 in the height direction. In another example shown in FIG. 11, the face 21e of the first pattern 2e is located between the first lines 22e of the first pattern 2e and the second surface 12 of the light-transmittable substrate 1 in the height direction.

In view of the foregoing, the article according to the present invention utilizes the first and second patterns 2, 2a, 2b, 2c, 2d, 2e, 3, 3a on the first and second surfaces 11, 11a, 12, 12b of the light-transmittable substrate 1, 1a to form a Moire pattern and to create Moire effect. The first lines 22, 22a, 22b, 22c, 22d, 22e intersect the second lines 32, 32a to cause a visual illusion, creating the 3D lively FIG. 4 with a three dimensional effect. The article is unique and has increased product value to increase competitiveness.

Although specific embodiments have been illustrated and described, numerous modifications and variations are still possible without departing from the essence of the invention. The scope of the invention is limited by the accompanying claims.

1. An article comprising:
a light-transmittable substrate including opposite first and second surfaces spaced in a height direction, with a first pattern provided on the first surface of the light-transmittable substrate and having a face, with a plurality of spaced first lines provided on the face of the first pattern, with a second pattern provided on the second surface of the light-transmittable substrate and having a face, with a plurality of spaced second lines provided on the face of the second pattern, with the plurality of first lines intersecting the plurality of second lines when viewed from the face of the first pattern, forming a Moire pattern and creating Moire effect, with light beams passing through the light-transmittable substrate via the first pattern or the second pattern according to a viewing angle of a viewer being refracted to represent a 3D lively figure.

2. The article as claimed in claim 1, with each of the plurality of first lines and the plurality of second lines having a color.

3. The article as claimed in claim 2, with the second pattern including a light-intransmittable base color.

4. The article as claimed in claim 1, with the first pattern or the second pattern including a light-transmittable protective layer.

5. The article as claimed in claim 1, with the first pattern being a first light-transmittable sheet having an inner face and an outer face, with the inner face of the first light-transmittable sheet bonded to the first surface of the light-transmittable substrate, with the outer face of the first light-transmittable sheet forming the face on which the first lines are located.

6. The article as claimed in claim 5, with the second pattern being a second light-transmittable sheet having an inner face and an outer face, with the inner face of the second light-transmittable sheet bonded to the second surface of the light-transmittable substrate, with the inner face of the second light-transmittable sheet forming the face on which the second lines are located.

7. The article as claimed in claim 1, with each of the plurality of first lines of the first pattern being light-transmittable and having a width larger than 0.1 mm in a width direction perpendicular to the height direction, with each of the plurality of first lines of the first pattern spaced from the face of the first pattern by a spacing in the height direction, with the spacing being in a range between 0.1 mm and 5 mm, with the light beams passing through the light-transmittable substrate via the first pattern according to the viewing angle of the viewer being refracted to represent the 3D lively figure.

8. The article as claimed in claim 7, with each of the plurality of first lines of the first pattern located between the face of the first pattern and the second surface of the light-transmittable substrate in the height direction, with the spacing between the face of the first pattern and each of the first lines being larger than 0.3 mm.

9. The article as claimed in claim 7, with the face of the first pattern located between the plurality of first lines of the first pattern and the second surface of the light-transmittable substrate in the height direction, with the spacing between the face of the first pattern and each of the plurality of first lines being larger than 0.3 mm in the height direction.
